(19) United States
(12) Patent Application Publication
(10) Pub. No.: US 2010/0211654 A1
(43) Pub. Date: Aug. 19, 2010

(54) COMMUNICATING INFORMATION-PROCESSING DEVICE AFFORDING RAPID ACCESS TO A SET OF PERSONAL INFORMATION

(76) Inventors: Mathieu LAGRANGE, Rennes (FR); Jean-Marie ROLLAND, Rennes (FR); Francois GALLIENNE, Rennes (FR)

Correspondence Address: NIXON & VANDERHYE, PC, 901 NORTH GLEBE ROAD, 11TH FLOOR, ARLINGTON, VA, 22203, US

(21) Appl. No.: 12/706,132

(22) Filed: Feb. 16, 2010

(30) Foreign Application Priority Data
Feb. 13, 2009 (FR) 09/50939

(51) Int. Cl. G06F 15/16

(52) U.S. Cl. 709/219

(57) ABSTRACT

In the field of nomadic computing, the invention concerns a communicating information processing device affording rapid access to a set of personal information.

This device has communication means affording access for it to a communication network, means for local storage of a set of data, means of synchronising this local set of data with at least one remote service accessible via the communication network. The device also has a version of an operating system able, when the device is connected to a terminal of the portable computer type, to enable the latter to boot up, and to load a set of applications managing data stored locally on the device. Advantageously, the set of applications also contains an application managing means of synchronising the local data with the remote service or services.

The present invention concerns the field of nomadic computing and a communicating information-processing device affording rapid access to a set of personal information.

It is more and more usual for users today to manage a set of data using a computer tool. These data may comprise traditional personal data consisting of the address book of the user and his use of time. These data are also supplemented by dynamic data such as various messages or events generated by communication services that may range from simple messaging services such as the electronic messaging service (email) to more elaborate services such as social network services such as “Facebook” (registered trade mark) or the like. They may also be supplemented by a set of documents that the user wishes to have available; these documents may be personal or related to his business activity such as projects, commercial catalogues or others.

In a context of ever increasing mobility, the user wishes to have access to this set of data chat is associated with him whether he be at home, in his office or during travel. Several ways of providing a solution to this problem of generalised access to a set of data exist at the present time.

A first way of responding to this problem consists of the development of portable information processing devices, referred to as terminals, such as portable computers (laptop computers) or personal digital assistants (PDAs). These devices have information processing means as well as storage means. They therefore make it possible to take with you a set of data and to access them everywhere.

One of the major problems with these solutions is the updating of the data. This is because we have seen that some of these data are by nature dynamic, such as the messages received from messaging services, moreover, even data such as the use of time are liable to undergo changes over time. For example, an assistant adds a meeting in your diary during travel. One of the responses to this problem consists of the relocation of the management services for these data. This concept is called cloud computing or online services. It consists of relocating the management of the data associated with a user onto services accessible to a communication network. It is now usual to subscribe to one or more online services making it possible to manage your personal data as well as access to communication services. A company such as “Google” (registered trade mark) is for example a pioneer in this type of service and it is also possible to cite “Live Service” (registered trade mark) of Microsoft (registered trade mark) or the “MobileMe” service (registered trade mark) of “Apple” (registered trade mark). Social network services being, by nature, online services.

If his information processing device is provided with communication means allowing him access to these online services, the user is then in a position to access his data from any place including the latest up-to-date version of these data. Two techniques for accessing remote data can be used. A first technique consists of directly managing the remote data using a local tool on the terminal making it possible to display and interact with these remote data. Typically, the user uses an internet browser affording communication with the remote server managing his data by means of the HTTP protocol (HyperText Transfer Protocol defined in RFC 2616). A second technique consists of having available locally on the terminal a copy of the data associated with the user and performing synchronising operations for ensuring coherence between the local copy of the set of data and the version of these data managed remotely on the server. These synchronisation operations are performed by means of the communication network, typically the internet. The advantages of the second solution are that it is possible to interact rapidly with the data available locally and it is also possible to have available locally a set of data containing data managed by different online services. Whereas, typically, online management can only be done service by service. On the other hand, between two data synchronisation operations, there is no guarantee that the local copy is in conformity with the latest modifications made to the remote data.

The terminals have different means of access to the communication networks such as the Internet. The most usual can be cited, such as cabled networks like the Ethernet that afford access to the internet through a local network. Then come the wireless communication networks, for example the WiFi network (the family of standards 802.11 of the IETF). Finally, the cellular wireless networks developed in the context of mobile telephony offer almost general availability with higher and higher bandwidths.

The problem posed to the nomadic user today, seeking to access a set of data managed by one or more so-called online services, is as follows. Say he has a mobile terminal of the PDA or mobile telephone type. This type of terminal generally offers a connection using cellular telephony services and therefore having good coverage with limited, but sufficient, bandwidth. These appliances are generally designed so as to be in an almost permanent state of operation, the startup time is in any event short and they therefore afford immediate or almost immediate access to the data that they contain. A major drawback of these terminals lies in the capacity of the input/output means offered to the user. In particular, they generally have very small screens and miniscule keypads making consultation and manipulation of the data uncomfortable. When the user has a terminal of the portable computer type, he does not always have a means of access to the cellular network and thereby has more restricted access to the communication network and therefore to access to online services. The computer to which the user has access when he wishes to access his data is not necessarily his personal computer configured to access the online services to which he has subscribed. In addition, this type of terminal functions typically by virtue of a computer operating system such as Windows (registered trade mark) of Microsoft (registered trade mark), MacOS X (registered trade mark) of Apple (registered trade mark) or the Linux free system (registered trade mark). These generalist operating systems are typically complex and because of this have lengthy startup times that may typically be as much as several minutes. Access to the data that they contain therefore requires waiting for the startup time of the operating system, and then of the data management application or applications. This time is deemed constraining in a mobility context where it is necessary to be able to quickly access the details of a contact or the like. These terminals of the portable computer type on the other hand offer the advantage of having input/output means that are much more comfortable such as a large screen and a complete keyboard. Consultation and manipulation of the data are therefore much more comfortable on these terminals than on terminals of the PDA or mobile telephone type.

The invention aims to solve the above problems by proposing an information processing device having communication means affording access to a communication network, means of local storage of a set of data, and means of synchronising this set of local data with at least one remote service accessible via the communication network. The said device also having a version of an operating system able, when the device is connected to a terminal of the portable computer type, to enable the latter to start up, and to load a set of data management applications stored locally on the device. Advantageously, the set of applications also contains an application managing the local data synchronisation means with the remote servers or services.

The invention concerns an information processing device comprising means of communication with a communication network; means of connection to a host machine; means of storing the information; means of managing a local copy in the information storage means of a set of personal data and which also comprises a copy of an operating system intended to be loaded and executed on the host machine and a set of applications intended to be loaded on the host machine and to be executed on the said operating system to allow access to and management of the data of the local copy of the set of personal data through means of connection between the said device and the said host machine, using the input/output peripherals of the said host machine.

According to a particular embodiment of the invention, the set of applications intended to be loaded on the host machine comprises means of synchronising the local copy of the set of personal data.

According to a particular embodiment of the invention, the host system consists of a version of Linux (registered trade mark) with the components not necessary for the execution of the host applications removed.

According to a particular embodiment of the invention, the host applications consist of web applications communicating with the means of managing a local copy and synchronisation of the personal data implemented in the form of a web server.

According to a particular embodiment of the invention, the storage space is a memory card connected to the device.

According to a particular embodiment of the invention, the device consists of a mobile telephony terminal.

According to a particular embodiment of the invention, it also comprises means of triggering a connection to the communication network and synchronising the local copy of personal data with the data managed by the online services, the device not being connected to the host machine.

According to a particular embodiment of the invention, it also comprises means of synchronising a type of personal data managed by a plurality of services online with each other.

According to a particular embodiment of the invention, it also comprises means of authenticating the user and means of enciphering the local data copy.

The invention also concerns a method of managing personal data that comprises a step of loading and executing a host system from an information processing device connected to a host machine, the loading taking place on the host machine; a step of loading and executing a set of host applications from the said device on the host machine; a step of collecting the set of host applications to the software resident on the device and a step of managing a local copy on the said device of a set of personal data by the set of host applications.

The invention also concerns a computer program stored on an information carrier, the said program comprising instructions for implementing the said personal data management method when it is loaded on and executed by a device as described previously.

The features of the invention mentioned above, as well as others, will emerge more clearly from a reading of the following description of an example embodiment, the said description being given in relation to the accompanying drawings, among which:

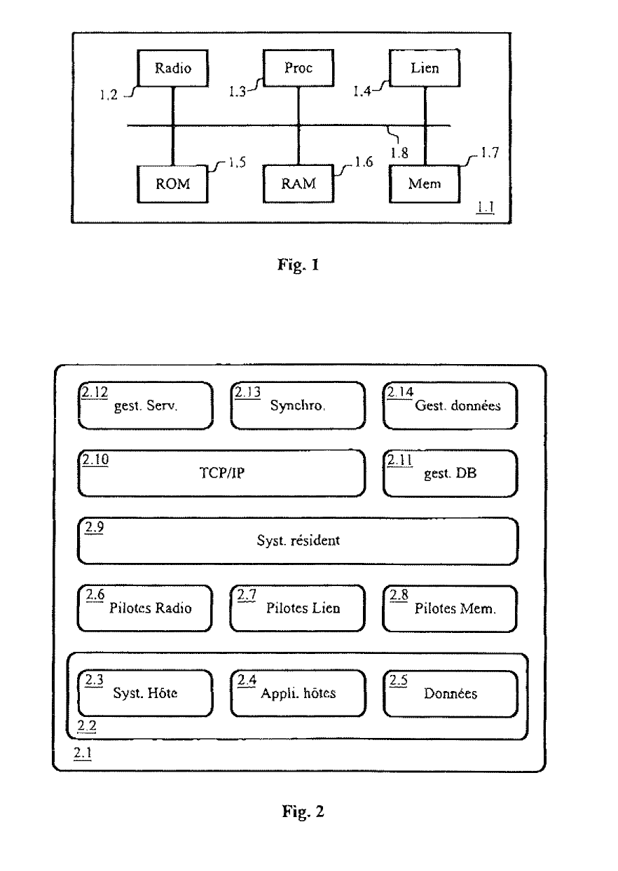

FIG. 1 illustrates the hardware architecture of an example embodiment of the device according to the invention;

FIG. 2 illustrates the functional architecture of the example embodiment of the invention;

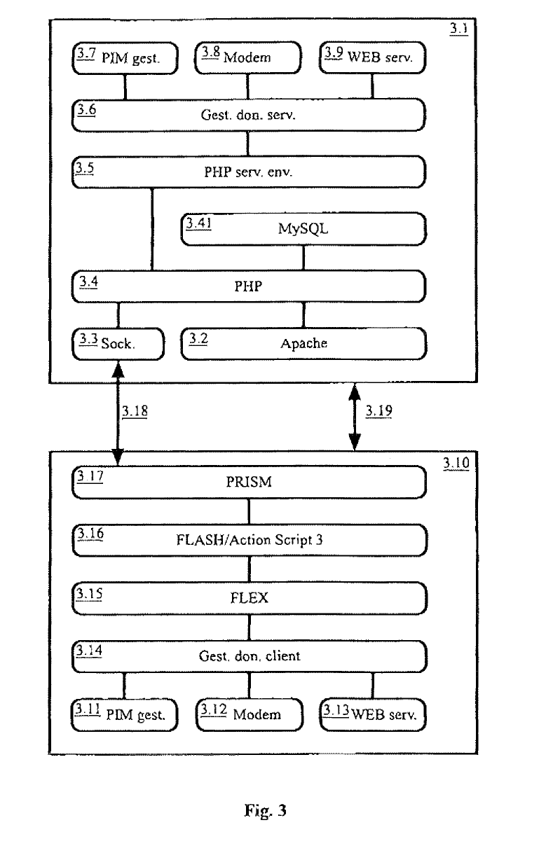

FIG. 3 illustrates more precisely the software blocks used in the example embodiment of the invention.

The problem addressed by the invention is to afford rapid and practical access to personal data or services in a mobility context for the user. It is based on a device that enables firstly connection to an information network, typically the internet, which affords access to online services. This device also has storage space allowing storage of a local copy on the device of all the data managed by the device. This device must remain compact in order to be easily transportable. This device also offers the particularity of having a version of an operating system dedicated to a host machine, as well as a set of applications intended, when they are executed on the host machine, for managing the device via the connection link between the device and the host machine. These applications at least allow control of a synchronisation operation between the local copies stored on the device and the online service or services. They also allow the display and the manipulation, addition, deletion and modification of the data stored in the local copy of the device. In this way the user is in a position to connect the device to a host machine, typically a portable computer, and to boot up the latter on the system hosted in the device in place of the resident system of the host machine. This host machine can be any machine, it can be borrowed for this use, it needs no specific programming or installation and no information will remain relating to this usage subsequent to its use. This booting up will then cause the loading of the applications manipulating the data on the host machine on top of the host system. In doing this, the user can very quickly access his data by using the input/output peripherals of the host machine. This is because the host machine is advantageously designed to run only dedicated applications, Booting up thereof is thereby made very rapid. The booting up of the operating system resident on the host machine is avoided, a generic system, comprising the starting up of a complete set of services, the majority being unnecessary for the application sought. According to the invention, the user is in a position to display and manipulate his data only a few seconds after having booted up the host machine by means of the device.

FIG. 1 illustrates the hardware architecture of an example embodiment of the device according to the invention. In this example, the device 1.1 consists of a processor 1.3 responsible for running the computer programs managing the device. These programs are partly situated in the read only memory 1.5 and use the random access memory 1.6 for their functioning. These resident programs consist typically of an operating system aimed at managing the functioning of the device, software modules managing the radio link and a module for managing the data. The device has an interface with the communication network 1.2. This interface is typically a radio link affording connection of the device with the network. The example embodiment allows connection to the mobile telephony network in data mode of the 3G/2G type. A person skilled in the art will understand that any type of network connection can be used here without departing from the scope of the invention, even if there is the advantage of choosing a type of connection having good coverage. A good bandwidth is also a plus for the functioning of the invention. A WiFi link, a Bluetooth (registered trade mark) link, or even a cabled link of the Ethernet type or the like, can be cited as a type of connection that can be used. The device also has a memory space 1.7 intended to store a version of an operating system intended for the host machine and the set of applications allowing management of the device from the host machine, which is called the host application. From a technical point of view, the read only memories hosting the resident programs of the device, the random access memory enabling its execution and the storage space can be implemented in various forms. It may be a case of the same rewritable memory component of the flash memory type, possibly in the form of a memory card that can be plugged into the device, separate components or any combination available to persons skilled in the art, Finally, the device comprises a link 1.4 that enables it to be connected to the host machine. This link must allow first the booting up of the host machine on the image of the host system available in the storage space 1.7, but it must also afford communication between all the management applications that are executed, after loading thereof from the storage space 1.7 on the host machine and the resident software of the device managing the radio link 1.2 and the storage space. Advantageously, this link enables a connection to be established according to the IP protocol between the device and the host machine. The example embodiment is based on the use of a USB (Universal Serial Bus) serial link, but other technologies such as the IEEE 1394 bus, an Ethernet link, WiFi or the like can be used here. The power supply to the device can be implemented by an onboard battery, not shown, or by the link connecting to the host machine. In the latter case, the device cannot function autonomously.

An example embodiment of the invention is based on a device having the appearance of a simple USE key. FIG. 2 illustrates the functional architecture of the example embodiment of the invention. The device 2.1 hosts the storage space 2.2, which contains the system intended for the host machine or host system 2.3, all the applications managing the personal data 2.4 intended to function on the host machine in cooperation with the host system 2.3 as well as a local copy of the personal data 2.5. This memory is managed by a driver module of the memory comprising a file system 2.8. It also includes a driver 2.6 for managing the connection to the communication network and a driver 2.7 for the link with the host machine. In the example embodiment, the connection is a 3G/2G mobile telephony link and the link with the host machine a USE link. The whole of the device is under the control of a resident operating system 2.9 cooperating with the previously described drivers. The example embodiment uses a version of Linux (registered trade mark). On top of this resident operating system we find a stack of communication protocols, typically the TCP/IP stack (Transmission Control Protocol and Internet Protocol defined by RFCs 791 and 793). This communication stack will afford communication with the communication network and also with the host machine. Advantageously, the device has a module for managing a data base 2.9 enabling personal data 2.5 to be managed. At the application level, there is a module for managing the online services 2.12 to which the user subscribes and which manages access to these services, connection identifiers, data recovery protocol, etc. A module 2.13 is responsible for managing the synchronisation between the data managed by the online services and the local copy of its data, while the module 2.14 is responsible for managing the data via the database 2.9.

FIG. 3 illustrates more precisely the software units used in the example embodiment of the invention, both for implementing the resident software of the device and in using the software intended for the host machine.

The set of management applications of the device used on the host machine 3.10 is based, in the example application, on the Prism (registered trade mark) module 3.17 of the Mozilla (registered trade mark) foundation. This module is an open source module for opening web applications in dedicated autonomous browser windows, free of any elements that have become superfluous such as the address bar, the menus, the tools or page marker of the Firefox (registered trade mark) browser. These dedicated windows can be started from the office and use the Gecko (registered trade mark) rendition engine of the same foundation, the same one that drives Firefox (registered trade mark). This module therefore offers a development environment for web applications. These are written by means of Flash/Action Script 3 (registered trade mark) technologies 3.16 from the company Adobe (registered trade mark). These technologies allow the management of highly developed graphical interfaces that can be driven by the Flex (registered trade mark) technology also from Adobe (registered trade mark). These modules are therefore modules available on the market. By means of these technologies there has been specially developed a set 3.14 of basic functionalities for management of the device, of the data, of the modem formed by the connection to the system of the device, and of online services. Specially developed dedicated modules enable the user to manage these personal data 3.11 or PIM (Personal Information Management), the modem 3.12 and the online services 3.13. This management of the online services comprising the management of the synchronisations between the local copy of the data on the device and the data managed online. This set of host applications can therefore communicate, typically by means of HTTP (HyperText Transport Protocol, defined by RFC 2616) requests by the link connecting the host machine and the device with a software assembly resident on the device 3.1. This is the link illustrated by the arrow 3.19 in the figure.

Cooperating with the previously described host software layers, software layers resident on the device enable the host applications to function We have seen that the host application assembly is based on web applications, these applications are therefore supplemented by means of managing a local copy and synchronising personal data implemented in the form of a web server resident on the device. There is first of all a web server 3.2 for serving the HTTP requests received, for example the Apache (registered trade mark) open source server. The server part of the applications is programmed using the PHP 3.4 programming language. Direction communication by TCP/IP sessions called socket 3.3 affords direct communication between the PHP 3.4 layer on the server and the Prism (registered trade mark) layer of the host machine. This communication is represented by the arrow 3.18 in the figure. The PHP layer makes it possible to manipulate the personal data managed by a data base 3.41, for example a MySQL (registered trade mark) base. Layers specific to the management of the functioning device have been developed by means of the standard software bricks. These layers comprise a layer 3.5 of generic functions managing the server environment 3.5, a layer of functions managing the server data 3.6 and specialised management modules, including the personal data manager 3.7, the modem manager 3.8 and the online service manager 3.9.

Alternatively, the server modules are integrated in the host application rather than resident on the device. The latter is then simply seen as a communication modem by all the host applications and as an external boot-up disk for the host machine. A simple PPP (Point to Point Protocol, defined by RFC 1661) connection then enables the host applications to drive the modem integrated in the device.

The host system is developed on the basis of a Linux (registered trade mark) open source system, but other solutions can be envisaged, for example real-time embedded systems. It is advantageous for the invention that the boot-up time of this system is made as short as possible. It is possible to use an existing system, or even to develop an ad hoc system. According to the embodiment, the system is a standard system of the Linux (registered trade mark) type modified to reduce the boot-up time. To do this, it has all the components not necessary to the functioning of the host applications described removed. The only parts necessary are the kernel of the system and the minimum drivers, that is to say the drivers managing the link used for the connection of the device, in this case the USE link, and the drivers managing the input/output peripherals of the host machine such as the screen, keyboard and pointing peripheral. The communication protocol stack necessary for communication between the device and the host machine, typically the TCP/IP stack, is also kept.

A person skilled in the art will understand that the technological choices made during the development of this example embodiment are not imitative of the invention. In particular, it is possible to construct variant embodiments from other software technologies, other communication protocols and other development environments of the modules, both client and server.

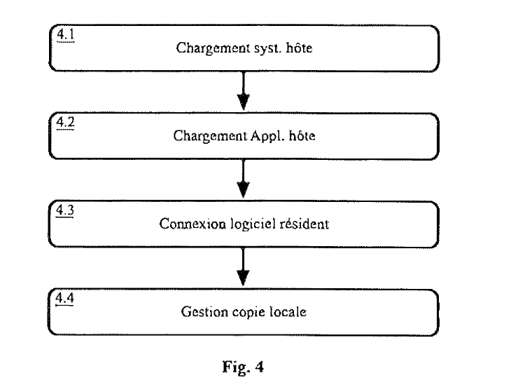

FIG. 4 illustrates the functioning of the device. It is used by connecting it to the host machine and causing the booting up of this host machine. The booting up then takes place on the resident storage space of the device rather than on the hard disk of the host machine. The image of the host machine stored on the storage space of the device is then loaded into the memory of the host machine and executed during a step 4.1. It is programmed to load into memory and execute the host applications also stored in the storage space of the device during a step 4.2. These applications are then connected to the software resident on the device during a step 4.3. The user then has an interface provided by the set of host applications enabling him to manage the local copy of data during a step 4.4. This management makes it possible to perform at least the following operations: display and editing of personal data contained in the local copy situated in the storage space of the device, management of the subscriptions of the user to one or more online services managing personal data, and advantageously the operations of synchronisation between the data contained in the local copy situated in the storage space of the device and the data of the online service or services subscribed to.

Optionally, when a type of personal data, such as the address book for example, is managed by more than one online service, the interface may propose synchronising the data managed by these services on line with each other. This operation may consist of a first synchronisation of the local address book and the online address book managed by a first service followed by a second operation of synchronising the local address book and the online address book managed by the second service. Following this second synchronisation, synchronisation via the local copy is performed between the address books of the two online services. This operation may be performed by all the local data and between more than two online services.

Advantageously, the local copy of the data of the user is enciphered on the device by enciphering means. In this case, access to his data requires an authentication step by the user. This authentication can be done by any means. For example, the device can be provided with biometric authentication means such as a fingerprint reader.

Advantageously, the device can be provided with an interface making it possible to request a synchronisation operation without requiring connection of the device to a host machine. The device must then be supplied autonomously. A simple button dedicated to this purpose then triggers an operation of connection to the communication network followed by an operation of synchronising the local copy of the personal data with the online services. In this way, the data are ready to be used and are up to date, when the device is connected to the host machine without requiring triggering via the host applications of this synchronisation.

It can be seen that the hardware architecture of the device constitutes a subassembly of many mobile telephony terminals. According to a particular embodiment of the invention, the device consists of such a standard mobile telephony terminal on which the software architecture of the invention is carried. In particular, the telephone is then provided with means of TCP/IP connection to the link connecting the telephone to a host machine as well as modules both resident and hosts as described previously.

When the device consists of a mobile telephony terminal therefore having its own input/output peripherals, it is possible also to give access to the data contained in the local copy of the storage space of the device via these peripherals autonomously apart from the connection of the host machine.

1. Information processing device comprising:
means of communication with a communication network, means of connection to a host machine;
means of storing the information;
means of managing a local copy in the information storage means of a set of personal data;
a copy of an operating system intended to be loaded onto and executed on the host machine;
a set of applications intended to be loaded onto the host machined and to be executed on the said operating system to allow access to and management of the data of the local copy of all the personal data through the means of connection between the said device and the said host machine, using the input/output peripherals of the said host machine;
characterised in that the set of applications intended to be loaded onto the host machine comprises means of synchronising the local copy of all the personal data and a version managed remotely on a server for these data.

2. Information processing device according to claim 1, characterised in that the host system consists of a version of Linux Cregistered trade mark) with components not necessary for the execution of the host applications removed.

3. Information processing device according to claim 1, characterised in that the host applications consist of web applications communicating with the means of managing a local copy and synchronisation of personal data implemented in the form of a server.

4. Information processing device according to claim 1, characterised in that the storage space is a memory card connected to the device.

5. Information processing device according to claim 1, characterised in that it consists of a mobile telephony terminal.

6. Information processing device according to claim 1, characterised in that it also comprises means of triggering a connection to the communication network and synchronising the local copy of personal data with the data managed by the online services, the device not being connected to the host machine.

7. Information processing device according to claim 1, characterised in that it also comprises means of synchronising a type of personal data managed by a plurality of online services with each other.

8. Information processing device according to claim 1, characterised in that it also comprises means of authenticating the user and means of enciphering the local data copy.

9. Method of managing personal data, characterised in that it comprises the following steps:
a step of loading and executing a host system from an information processing device connected to a host machine, the loading taking place onto the host machine;
a step of loading and executing a set of host applications from the said device on the host machine;
a step of connecting the set of host applications to the software resident on the said device;
a step of managing a local copy on the said device of a set of personal data by the set of host applications.

10. Computer program stored on an information carrier, the said program comprising instructions for implementing the personal data management method according to claim 9, when it is loaded onto and executed by a device.
